(19) United States
(12) Patent Application Publication
(10) Pub. No.: US 2021/0249992 A1
(43) Pub. Date: Aug. 12, 2021

(54) SOLAR PANEL SYSTEM AND MAINTENANCE METHOD

(71) Applicant: Tsur Rochman, Rishon Lezion (IL)

(72) Inventor: Tsur Rochman, Rishon Lezion (IL)

(21) Appl. No.: 16/954,474

(22) PCT Filed: Jun. 11, 2019
(86) PCT No.: PCT/IL2019/050662

§ 371 Date: Jun. 16, 2020

(30) Foreign Application Priority Data
Jun. 18, 2018 (IL) 260112

(51) Int. Cl. H02S 40/10; B08B 3/02; B08B 13/00; H02S 20/32

(52) U.S. Cl. CPC H02S 40/10; H02S 20/32; B08B 13/00; B08B 3/02

(57) ABSTRACT

A solar panel system and maintenance method, the system is configured to receive from a sensor module an indication about the environmental conditions in the surroundings of the solar panel, turn the energy-absorbent face of the solar panel to face the sun when sufficient daylight is detected by the sensor module, and to turn the energy-absorbent face of the solar panel to face the surface when the sensed conditions are not suitable for energy absorbance, wherein insufficient daylight constitute a sensed condition not suitable for energy absorbance; and each time the solar panel is tilted so that the energy-absorbent face of the solar panel faces the surface, control a sprinkle module to sprinkle a liquid at the energy-absorbent face.

### BACKGROUND

Some known solar energy power generation devices include solar auto-tracking function that detects the position of the sun, control the rotation of the solar panel, keep the current angle to the maximum degree of absorption of energy from the sun, greatly improving the efficiency of solar energy conversion. However, the solar panels collect dust and debris which heavily obscures the reception of energy and may reduce the energy absorption by more than 50 percent. Additionally, almost any heating reduces the efficiency of the solar panels significantly, wherein the solar energy is best absorbed in very cold weather, and reduced very quickly as the panel is heated. There are cleaning robots to be installed separately on each panel and are usually very expansive and cumbersome for installation. Therefore, in some cases the panels are left with degraded efficiency. This problem is particularly noticeable when dealing with solar farms which may include tens or hundreds of solar panels.

CN 206894582 discloses an electronic information technical field, intelligent house field especially relate to a novel solar energy power generation optimizes device. Including single chip main control unit to and sun auto-tracing module, cleaning module, “protection room” module, wireless remote control module and electrical energy storage output module. Solar energy auto-tracing module include solar cell panel module, photosensitive module and motor module, rotate by the output shaft control solar cell panel module of motor module, photosensitive module detects solar cell panel and goes up illumination intensity signal to give single chip main control unit with signal transmission, cleaning module is provided with rotatory cleaning arm, sets up the cleaning brush on the rotatory cleaning arm, and rotatory cleaning arm installs on the solar cell panel surface. “protection room” module includes that sensor module (light intensity sensor, humidity transducer and air velocity transducer), protection box, elevating gear and solar cell panel contract the module automatically, have sun auto-tracing function, clean function, safeguard function.

U.S. Pat. No. 7,730,676 discloses a solar panel supporting system that includes a main frame, a solar panel, and a spring mechanism. The main frame has two opposite lateral sides. The solar panel is pivotally mounted on the main frame along a first pivot axis defined by a first rod extending between the opposite lateral sides of the main frame. The spring mechanism is operatively coupled to the solar panel for resiliently holding the solar panel at a predetermined position. The solar panel is adapted to pivot in response to wind strong enough to stretch or compress the spring mechanism.

US 2018/054156 discloses a solar tracker that includes a main platform capable of supporting a plurality of solar panels, a sub-platform, one or more support poles supporting the sub-platform and a linking mechanism that connects the sub-frame to the apex of the one or more supporting poles, wherein the linking mechanism rotates in a first axis, a second linking mechanism rotates in a second axis. The mail planar platform hosting the solar panels is encompassed with edge disrupters and spacing channels for adverse wind condition management. The system includes a solar tracker system includes a radiation sensor for determining the best tracking position for maximizing capture of solar energy. The large scale solar tracker system also includes at least two linear hydraulic actuators, each linear hydraulic actuator containing a distal end and proximal end, a rotational joint that connects the distal end of the linear actuators to the sub-platform and the proximal end to the support beam. The second embodiment of the present invention is a plurality of solar tracker apparatus specifically arranged into a large utility scale field system.

WO 2016/197013 discloses an apparatus, method and system for cleaning a solar panel includes a solar panel, one or more fluid reservoirs, a fluid dispenser at a first side of a solar panel, a mechanism for providing pressurized fluid to the fluid dispenser from the fluid reservoir(s), and a mechanism for dispensing the fluid from the dispenser. The solar panel is periodically cleaned and the motivation for cleaning may be a detected output condition of the panel, a detected weather condition, an expired time condition, detected precipitant accumulation, a manual command, or the like. The fluid(s) may include a gas and/or one or more liquids. A heater may be provided to heat the fluid(s).

### SUMMARY

An aspect of some embodiments of the present disclosure provides a solar panel system including at least one solar panel having an energy absorbent face and a non-absorbent rear face, the panel is mechanically connected to a main actuator, the main actuator is configured to tilt the at least one solar panel, wherein the at least one solar panel is installed above a surface, a sensor module configured to detect environmental conditions in the surroundings of the at least one solar panel, a sprinkler module comprising at least one sprinkler units, each located between a corresponding solar panel and the surface, and a controller configured to: receive from the sensor module an indication about the environmental conditions in the surroundings of the solar panel, turn the energy-absorbent face of the solar panel to face the sun when sufficient daylight is detected by the sensor module, and to turn the energy-absorbent face of the solar panel to face the surface when the sensed conditions are not suitable for energy absorbance, wherein insufficient daylight constitute a sensed condition not suitable for energy absorbance, and each time the solar panel is tilted so that the energy-absorbent face of the solar panel faces the surface, control the sprinkle module to sprinkle a liquid at the energy-absorbent face.

Optionally, the system includes a panel actuator fixedly connected to the rear face of the solar panel or within a thickness of the solar panel.

Optionally, the panel actuator is rotatably or fixedly connected to an axle installed in parallel to the surface.

Optionally, the panel actuator is rotatable about a longitudinal axis of the axle.

Optionally, the panel actuator is rotatable with a longitudinal axis of the axle.

Optionally, the axle is rotatably connected to a beam vertical to the surface.

Optionally, the sensor module is configured to detect at least one of a list consisting of: light intensity, UV radiation, temperature, wind speed, dust and precipitation.

Optionally, the sensor module comprises at least one of a list consisting of: a light sensor, a camera, a thermometer, a barometer, a wind sensor, a dust-storm detector, a precipitation detector and a precipitation-type detector.

Optionally, the controller is configured to turn the energy-absorbent face of the solar panel to face the surface, when the sensed conditions in the surroundings of the at least one solar panel may be harmful for the panel.

Optionally, the sprinkler module comprises a main source of cleaning liquid and at least one sprinkler unit with an orifice through which the cleaning liquid is sprinkled by the controller.

Optionally, the controller is configured to control the solar panel to be oriented in a certain angle upon receiving an external command or at predetermined periods.

An aspect of some embodiments of the present disclosure provides a solar panel maintenance method comprising: receiving from a sensor module an indication about the environmental conditions in the surroundings of at least one solar panel, the at least one solar panel having an energy absorbent face and a rear face, the panel is mechanically connected to a main actuator, the main actuator is configured to tilt the at least one solar panel, wherein the at least one solar panel is installed above a surface, controlling the solar panel to turn the energy-absorbent face of the solar panel to face the sun when sufficient daylight is detected by the sensor module, and to turn the energy-absorbent face of the solar panel to face the surface when the sensed conditions are not suitable for energy absorbance, wherein insufficient daylight constitute a sensed condition not suitable for energy absorbance, and each time the solar panel is tilted so that the energy-absorbent face of the solar panel faces the surface, controlling a sprinkle module to sprinkle a liquid at the energy-absorbent face, wherein the sprinkler is located between a corresponding solar panel and the surface.

Optionally, the method includes tilting the solar panel so that an energy-absorbent face of the solar panel faces the surface, upon receiving from the sensor module indication that the environmental conditions in the surroundings of the solar panel may be harmful for the panel.

### BRIEF DESCRIPTION OF THE DRAWINGS

Some non-limiting exemplary embodiments or features of the disclosed subject matter are illustrated in the following drawings.

In the drawings:

FIG. 1 is a schematic illustration of a solar panel system, according to some embodiments of the present invention;

FIG. 2 is a schematic illustration of a solar panel system showing an energy-absorbent face of the solar panel turned to the sun, according to some embodiments of the present invention;

FIG. 3 is a schematic illustration of a solar panel system showing an energy-absorbent face of the solar panel turned to the surface, according to some embodiments of the present invention; and

FIG. 4 is a schematic flowchart illustrating a solar panel maintenance method, according to some embodiments of the present invention.

With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

Identical or duplicate or equivalent or similar structures, elements, or parts that appear in one or more drawings are generally labeled with the same reference numeral, optionally with an additional letter or letters to distinguish between similar entities or variants of entities, and may not be repeatedly labeled and/or described. References to previously presented elements are implied without necessarily further citing the drawing or description in which they appear.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

### DETAILED DESCRIPTION

Before explaining at least one embodiment of the disclosure in detail, it is to be understood that the disclosure is not necessarily limited in its application to the details of construction and the arrangement of the components and/or methods set forth in the following description and/or illustrated in the drawings and/or the Examples. The disclosure is capable of other embodiments or of being practiced or carried out in various ways.

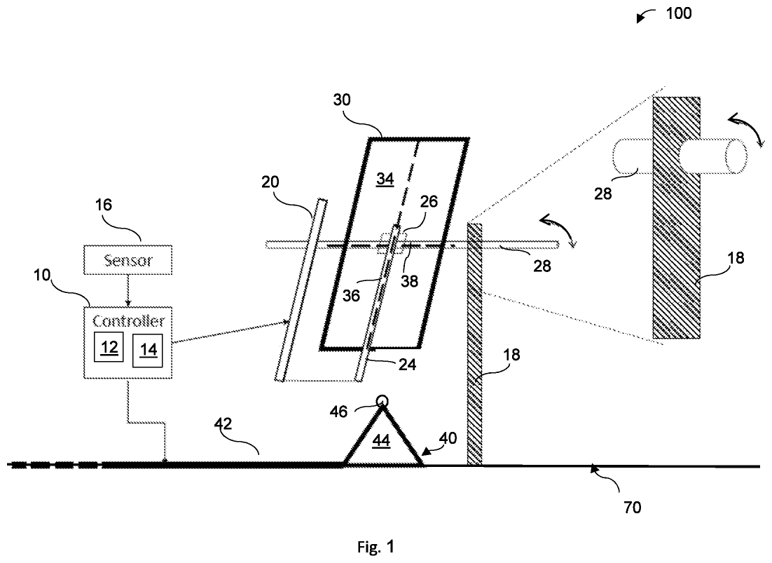

Reference is now made to FIG. 1, which is a schematic illustration of a solar panel system 100, according to some embodiments of the present invention. Solar panel system 100 may include a controller 10, a sensor module 16, a beam 18, a main actuator 20, a panel actuator 24, at least one connector 26, an axle 28, a solar panel 30, and a sprinkler module 40.

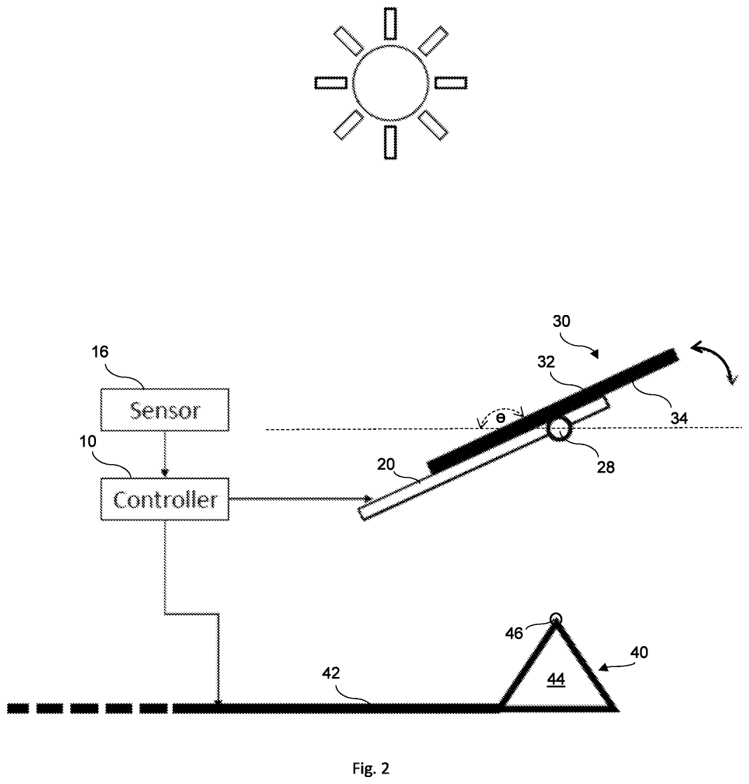

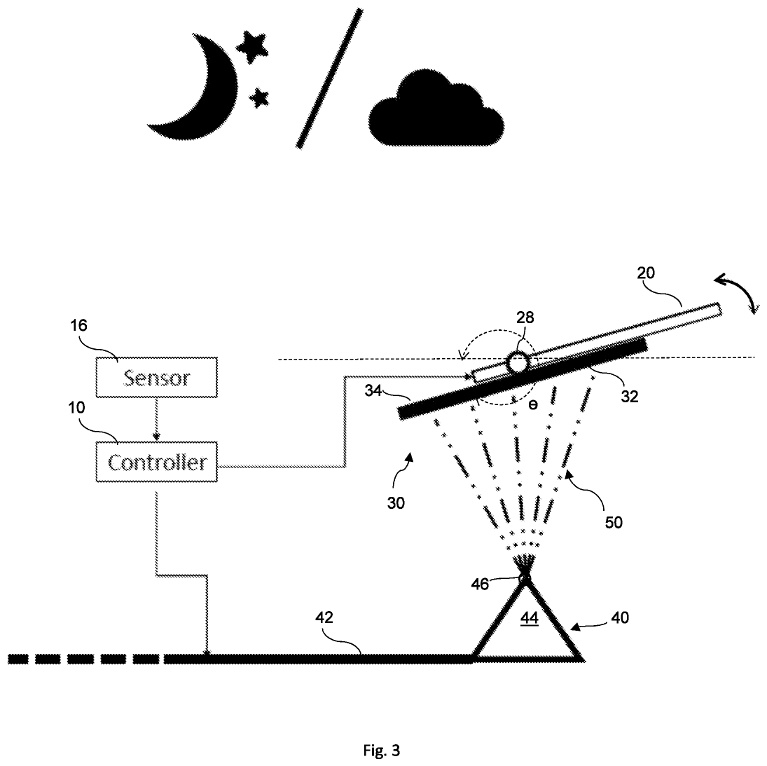

Solar panel 30 may have an energy-absorbent face 32 (shown, for example, in FIGS. 2 and 3) adapted to absorb solar energy, for example in order to transform the absorbed energy to electricity, and a rear, non-absorbent face 34. Solar panel 30 may have a longitudinal axis 36 and a transverse axis 38. Panel actuator 24 may be fixedly connected to solar panel 30 on rear face 34 and/or within a thickness of solar panel 30, for example along longitudinal axis 36, for example by connector 26. Solar panel 30 and/or panel actuator 24 may be rotatably or fixedly connected to axle 28. For example, solar panel 30 and/or panel actuator 24 are rotatable about a longitudinal axis of axle 28. In some embodiments, solar panel 30 and/or panel actuator 24 are rotatable with axle 28 or rotatable about axle 28, or rotatable about the longitudinal axis of axle 28 by another form of connector. In some embodiments, solar panel 30 is fixed to panel actuator 24 such that in case panel actuator 24 is moved to rotate about the longitudinal axis of axle 28, solar panel 30 rotates together with actuator 24. For example, panel actuator 24 is moveable by main actuator 20. For example, main actuator 20 may be mechanically-connected to panel actuator 24.

Beam 18 may be vertical to a surface and affixed to the surface at one end, with a proximal end above the surface. The surface may include a natural soil, concrete, or any other suitable substrate, and may be a ground, a roof, a floor, or any other suitable kind of surface. Axle 28 may be perpendicularly connected to beam 18, such that axle 28 is substantially parallel to the surface. In some embodiments, axle 28 may be rotatably connected to beam 18.

Sensor module 16 may include detectors and/or may be configured to detect environmental conditions such as light intensity, UV radiation, temperature, wind speed, dust, precipitation, and/or any other suitable kind of environmental conditions. For example, sensor module 16 includes a light sensor, a camera, a thermometer, a barometer, a wind sensor, a dust-storm detector, a precipitation and/or precipitation-type detector, and/or any other suitable kind of detectors of environmental conditions.

Controller 10 may include at least one hardware processor 12 and a hardware non-transitory memory 14. Memory 14 may store code instructions executable by at least one processor 12. When executed by at least one processor 12, the stored code instructions cause processor 12 to carry out the methods described herein.

In some embodiments of the present invention, controller 10 receives information signals from sensor module 16, and controls panel 30 based on the information included in the received information signals. For example, controller 10 controls main actuator 20, which in turn moves panel actuator 24. Controller 10 may monitor and control tilt angles in which panel 30 is tilted relative to various directions, in order to maintain optimal orientation of panel 30, for optimal solar efficiency. For example, when sensor module 16 detects daylight, as shown in FIG. 2, controller 10 may turn panel 30, e.g. control main actuator 20 to tilt panel 30, so that energy-absorbent face 32 faces the sun, for example to be tilted in an angle Θ (theta) of between 90 to 270 degrees relative to surface 70. According to some embodiments of the present invention, when a suitable condition or set of conditions is fulfilled, controller 10 turns energy-absorbent face 32 of panel 30 to face surface 70, for example to have an angle theta relative to surface 70, of between 0 to 90 degrees or 270-360 degrees relative to surface 70, as shown in FIG. 3. It will be appreciated that when theta equals about 0 (or 360) degrees, energy-absorbent face 32 faces surface 70 and is substantially parallel to surface 70.

Sprinkler module 40 may include a main source 42 of cleaning liquid 50, and a sprinkler unit 44 with an orifice 46, through which the cleaning liquid 50 may be sprinkled. The cleaning liquid may include, for example, water, soft water and/or a detergent and/or any suitable cleaning liquid. Controller 10 may control main source 42 to provide the cleaning liquid to sprinkler unit 44, for example for a predetermined period of time. For example, each time energy-absorbent face 32 is turned to face surface 70, and/or any other condition is fulfilled, Controller 10 controls main source 42 to provide the cleaning liquid to sprinkler unit 44, and/or sprinkler unit 44 to sprinkle the liquid at energy-absorbent face 32, for example for a predetermined period of time. Thus, energy-absorbent face 32 is cleaned and/or cooled down when not used for energy-absorbing.

It will be appreciated that when a large solar farm is concerned, the entire farm, e.g. all the panels may be turned and cleaned concurrently, thus, for example, cleaning the entire solar farm within a few minutes or less. Additionally, the provided system requires much less human resources, used in known systems for maintenance, cleaning, robot installation and maintenance, etc.

Accordingly, it will be appreciated that solar panels and solar panel farms made according to the present disclosure are practically clean at all utilizable times, i.e. whenever the conditions in the surroundings of the panels enable solar energy to be absorbed, e.g. in sunny weather. This may increase the efficiency of the solar panels, for example, in up to 50% relative to known systems.

Additionally, in some embodiments of the present invention, controller 10 may control solar panel 30 to be oriented in a certain angle, for example upon receiving an external command or at predetermined periods. The ability to orient panel 30 upon receiving an external command or at predetermined periods enables, for example, making a space for maintenance vehicles to pass between panel rows in a solar farm. Thus, for example, the spaces between panels during energy absorbance may be smaller and the solar farm, as a whole, may be more efficient, i.e. providing more energy for a smaller area.

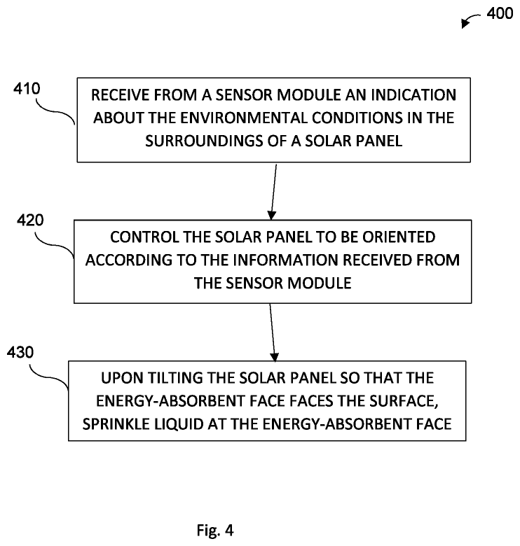

Reference is now made to FIG. 4, which is a schematic flowchart illustrating a method 400 for solar system maintenance, according to some embodiments of the present invention. As indicated in block 410, processor 12 may receive from sensor module 16 an indication about the environmental conditions in the surroundings of solar panel 30. For example, the indication may include weather, environment and/or pollution conditions in the environment of solar panel 30. For example, processor 12 may receive an indication that the environmental conditions in the surroundings of solar panel 30 are not suitable for energy absorbance and/or may be harmful for panel 30. For example, such indication may be received when there is a lot of dust in the air, the air is polluted, it is cloudy, windy, rainy, snowy, panel 30 is too hot, there is insufficient daylight and/or any other suitable condition. In other cases, processor 12 may receive from sensor module 16 an indication that the environmental conditions in the surroundings of solar panel 30 are suitable for energy absorbance, for example when a sufficient intensity of daylight and/or UV radiation is detected and, for example, none of the conditions not suitable for solar energy absorbing is detected.

As indicated in block 420, processor 12 may control panel 30 to rotate and/or to be oriented so that energy-absorbent face 32 faces the sun, faces surface 70, or to be oriented in any other suitable direction, according to the information received from sensor module 16. For example, in case processor 12 receives an indication that the environmental conditions in the surroundings of solar panel 30 are not suitable for energy absorbance and/or may be harmful for panel 30, processor 12 may control solar panel 30 to rotate and/or to be oriented so that energy-absorbent face 32 faces surface 70, as described in detail herein above. For example, in case processor 12 receives an indication that the environmental conditions in the surroundings of solar panel 30 are suitable for energy absorbance, processor 12 may control solar panel 30 to rotate and/or to be oriented so that energy-absorbent face 32 faces the sun, as described in detail herein above.

As indicated in block 430, upon tilting solar panel 30 so that energy-absorbent face 32 faces surface 70, processor 12 may control main liquid source 42 to provide the cleaning liquid to sprinkler unit 44, and/or may control sprinkler unit 44 to sprinkle the liquid at energy-absorbent face 32, for example for a predetermined period of time, for example in order to clean energy-absorbent face 32. For example, processor 12 is configured to control the sprinkle module to sprinkle a liquid at the energy-absorbent face each time solar panel 30 is tilted so that the energy-absorbent face 32 of the solar panel faces the surface.

Some embodiments of the present disclosure may include a system, a method, and/or a computer program product. The computer program product may include a tangible non-transitory computer readable storage medium (or media) having computer readable program instructions thereon for causing a processor to carry out aspects of the present disclosure. Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including any object-oriented programming language and/or conventional procedural programming languages.

In the context of some embodiments of the present disclosure, by way of example and without limiting, terms such as ‘operating’ or ‘executing’ imply also capabilities, such as ‘operable’ or ‘executable’, respectively.

Conjugated terms such as, by way of example, ‘a thing property’ implies a property of the thing, unless otherwise clearly evident from the context thereof.

The terms ‘processor’ or ‘computer’, or system thereof, are used herein as ordinary context of the art, such as a general purpose processor, or a portable device such as a smart phone or a tablet computer, or a micro-processor, or a RISC processor, or a DSP, possibly comprising additional elements such as memory or communication ports. Optionally or additionally, the terms ‘processor’ or ‘computer’ or derivatives thereof denote an apparatus that is capable of carrying out a provided or an incorporated program and/or is capable of controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as a memory.

The terms ‘software’, ‘program’, ‘software procedure’ or ‘procedure’ or ‘software code’ or ‘code’ or ‘application’ may be used interchangeably according to the context thereof, and denote one or more instructions or directives or electronic circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry. The processor and program may constitute the same apparatus, at least partially, such as an array of electronic gates, such as FPGA or ASIC, designed to perform a programmed sequence of operations, optionally comprising or linked with a processor or other circuitry.

The term ‘configuring’ and/or ‘adapting’ for an objective, or a variation thereof, implies using at least a software and/or electronic circuit and/or auxiliary apparatus designed and/or implemented and/or operable or operative to achieve the objective.

A device storing and/or comprising a program and/or data constitutes an article of manufacture. Unless otherwise specified, the program and/or data are stored in or on a nontransitory medium.

In case electrical or electronic equipment is disclosed it is assumed that an appropriate power supply is used for the operation thereof.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated or described operations may occur in a different order or in combination or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprising”, “including” and/or “having” and other conjugations of these terms, when used in this specification, specify the presence of stated features, integers, steps, operations, elements, and/or components, but do not preclude the presence or addition of one or more other features, integers, steps, operations, elements, components, and/or groups thereof.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

1. A solar panel system comprising:
at least one solar panel having an energy absorbent face and a non-absorbent rear face, the panel is mechanically connected to a main actuator, the main actuator is configured to tilt the at least one solar panel, wherein the at least one solar panel is installed above a surface;
a sensor module configured to detect environmental conditions in the surroundings of the at least one solar panel;
a sprinkler module comprising at least one sprinkler units, each located between a corresponding solar panel and the surface; and
a controller configured to:
receive from the sensor module an indication about the environmental conditions in the surroundings of the solar panel;
turn the energy-absorbent face of the solar panel to face the sun when sufficient daylight is detected by the sensor module, and to turn the energy-absorbent face of the solar panel to face the surface when the sensed conditions are not suitable for energy absorbance, wherein insufficient daylight constitute a sensed condition not suitable for energy absorbance;
and each time the solar panel is tilted so that the energy-absorbent face of the solar panel faces the surface, control the sprinkle module to sprinkle a liquid at the energy-absorbent face.

2. The solar panel system according to claim 1, comprising a panel actuator fixedly connected to the rear face of the solar panel or within a thickness of the solar panel.

3. The solar panel system according to claim 2, wherein the panel actuator is rotatably or fixedly connected to an axle installed in parallel to the surface.

4. The solar panel system according to claim 3, wherein the panel actuator is rotatable about a longitudinal axis of the axle.

5. The solar panel system according to claim 3, wherein the panel actuator is rotatable with a longitudinal axis of the axle.

6. The solar panel system according to claim 5, wherein the axle is rotatably connected to a beam vertical to the surface.

7. The solar panel system according to claim 1, wherein the sensor module is configured to detect at least one of a list consisting of: light intensity, UV radiation, temperature, wind speed, dust and precipitation.

8. The solar panel system according to claim 1, wherein the sensor module comprises at least one of a list consisting of: a light sensor, a camera, a thermometer, a barometer, a wind sensor, a dust-storm detector, a precipitation detector and a precipitation-type detector.

9. The solar panel system according to claim 1, wherein the controller is configured to turn the energy-absorbent face of the solar panel to face the surface, when the sensed conditions in the surroundings of the at least one solar panel may be harmful for the panel.

10. The solar panel system according to claim 1, wherein the sprinkler module comprises a main source of cleaning liquid and at least one sprinkler unit with an orifice through which the cleaning liquid is sprinkled by the controller.

11. The solar panel system according to claim 1, wherein the controller is configured to control the solar panel to be oriented in a certain angle upon receiving an external command or at predetermined periods.

12. A solar panel maintenance method comprising:
receiving from a sensor module an indication about the environmental conditions in the surroundings of at least one solar panel, the at least one solar panel having an energy absorbent face and a rear face, the panel is mechanically connected to a main actuator, the main actuator is configured to tilt the at least one solar panel, wherein the at least one solar panel is installed above a surface;
controlling the solar panel to turn the energy-absorbent face of the solar panel to face the sun when sufficient daylight is detected by the sensor module, and to turn the energy-absorbent face of the solar panel to face the surface when the sensed conditions are not suitable for energy absorbance, wherein insufficient daylight constitute a sensed condition not suitable for energy absorbance; and
each time the solar panel is tilted so that the energy-absorbent face of the solar panel faces the surface, controlling a sprinkle module to sprinkle a liquid at the energy-absorbent face, wherein the sprinkler is located between a corresponding solar panel and the surface.

13. The maintenance method of claim 12, comprising tilting the solar panel so that the energy-absorbent face of the solar panel faces the surface, upon receiving from the sensor module indication that the environmental conditions in the surroundings of the solar panel may be harmful for the panel.
